(19) United States
(12) Patent Application Publication
(10) Pub. No.: US 2026/0243316 A1
(43) Pub. Date: Aug. 20, 2026

(54) Hydrostatic Rotary Machine with Brake Discs Mounted on Bolts

(71) Applicant: Robert Bosch GmbH, Stuttgart (DE)

(72) Inventors: Craig Gudmundsson, Stanley Perth (GB); Johann Praeffcke, Scotlandwell (GB); Laurent Eugene Albert, Frignicourt (FR)

(21) Appl. No.: 19/538,135

(22) Filed: Feb. 12, 2026

(30) Foreign Application Priority Data
Feb. 19, 2025 (DE) 10 2025 106 171.8

(51) Int. Cl. F16D 55/40; F16D 55/00; F16D 65/18; F16D 121/06; F16D 125/06; F16D 125/36

(52) U.S. Cl. CPC F16D 55/40; F16D 65/186; F16D 2055/007; F16D 2121/06; F16D 2125/06; F16D 2125/36

(57) ABSTRACT

A hydrostatic rotary machine has an inner and an outer element, which are coaxial with respect to an axis of rotation and rotatable relative to one another. One of these elements is a rotor and the other of these element is a stator. Pistons, which are movable in cylinders, can cooperate with a cam track in such a way that a rotational movement of the rotor is associated with a stroke movement of the pistons. A brake is provided which is designed to counteract the rotational movement of the rotor relative to the stator. The brake includes a plurality of first and a plurality of second brake discs arranged alternately along the axis of rotation. The first brake discs are rotationally fixedly connected to the outer element with respect to the axis of rotation. At least two bolts each extending parallel to the axis of rotation are provided. They are fixedly connected to the inner element at a single first end facing toward the axis of rotation. Each bolt intersects all second brake discs such that the second brake discs are rotationally fixedly connected to the inner element with respect to the axis of rotation.

This application claims priority under 35 U.S.C. § 119 to application no. DE 10 2025 106 171.8, filed on Feb. 19, 2025 in Germany, the disclosure of which is incorporated herein by reference in its entirety.

### BACKGROUND

The disclosure relates to a hydrostatic rotary machine according to the description set forth below.

A hydrostatic rotary machine in the form of a radial piston motor is known from EP 3 233 553 B1. In a radial piston motor, the outer element forms the stator, and the inner element forms the rotor. The inner element is coaxially supported with respect to the outer element and rotatable relative to an axis of rotation on the outer element. A shaft-like cam track is further provided on an inner circumferential surface of the outer element. The pistons are movably received in cylinders of the inner element. They interact with the cam track via rotatable rollers such that a rotational movement of the rotor can cause a stroke movement of the pistons and vice versa.

A brake is further provided, which is configured in the form of a multi-disc brake. The first and the second brake discs of the brake are arranged around a fluid distributor to conserve space. The second brake discs are rotationally fixedly connected to an annular projection, which is formed integrally by a base body of the inner element. As a result, the manufacture of this base body is very expensive. The base body mentioned is manufactured by machining, wherein the ring-like protrusion mentioned requires a very large piece of raw material, the machining of which takes a long time.

An advantage of the present disclosure is that the manufacture of the hydrostatic rotary machine can be much more cost-effective without compromising the performance of the brake.

### SUMMARY

According to the following description, it is proposed that at least two bolts each extending parallel to the axis of rotation are provided, wherein they are fixedly connected to the inner element at a single first end facing toward the axis of rotation, wherein each bolt intersects all second brake discs, such that the second brake discs are rotationally fixedly connected to the inner element with respect to the axis of rotation. A multi-disc brake, in which a set of brake discs are received on a plurality of bolts, is known from U.S. Pat. No. 3,722,637 A, for example. With such multi-disc brakes, however, the bolts are always supported at both opposite ends, as they must transfer very large forces. This cannot be implemented in the hydrostatic rotary machine according to EP 3 233 553 B1. The inventors have therefore overcome the preconception that only two-sided bolts can transfer the forces occurring in a multi-disc brake. They also saw that it is possible, especially with a hydrostatic rotary machine, to make the bolts so solid and secure them to the remaining inner element, such that they can support the braking forces occurring during operation with the required stiffness.

The outer element preferably forms the stator, wherein the inner element forms the rotor. The reverse assignment is also conceivable. The cam track is preferably arranged on the stator with the cylinders arranged on the rotor. The reverse assignment is also conceivable. It is highly preferable for the cam track to be arranged on the inside of the outer element.

Advantageous developments and improvements of the disclosure are specified in the description set forth below.

It may be contemplated that the number of bolts equals the number of pistons. A large number of bolts can thereby be used so that each individual bolt is under low load. Moreover, all bolts away from the cylinder may be attached very stiffly to the remaining inner element without the need for more design space for the inner element.

It may be provided that the pistons and the bolts are each arranged uniformly distributed around the axis of rotation, wherein the bolts are arranged circumferentially with respect to the axis of rotation between the pistons. In this area, the inner element is formed very solidly so that the bolts can be attached there very stiffly.

It may be provided that a radially outward facing extension is associated with each bolt on all first brake discs, wherein the extensions engage in a respective associated groove on the outer element. When the brake is closed, the braking force is transferred a particularly short distance from the extensions to the bolts via the brake discs. As a result, elastic deformations on the brake are minimized under the action of the braking forces. It is noted in this case that multi-disc brakes can cause noises, in particular squeaking noises, that are to be avoided as much as possible. The elastic deformations mentioned may be a cause of such undesirable noises, wherein tests carried out by the applicant have shown that the hydrostatic rotary machine according to the disclosure does not squeak.

It can be provided that the bolts are each designed as separate components, each of which is screwed into the inner element at the first end. The screw connection can be secured against disengaging, for example with an adhesive. In this way, the desired stiff connection between the bolts and the remaining inner element can be made in a particularly inexpensive and straightforward manner.

It can be provided that the bolts are provided with a positive locking mechanism at a second end facing away from the first end in the direction of the axis of rotation, which are configured for positively engaging with a screwing tool. This simplifies the assembly of the bolts. The positive locking mechanism can be, for example, an outer hexagon, an inner hexagon, a torx inner profile or a slot.

It may be provided that the bolt has a circular cylindrical portion outside the inner element, the cylinder axis of which is arranged parallel to the axis of rotation, wherein the second brake discs are arranged in the area of the circular cylindrical portion. Preferably, all second brake discs are arranged in the area of the circular cylindrical portion. The positive engagement between the circular cylindrical portion and the second brake discs subsequently causes little surface compression at the surface of the circular cylindrical portion. Moreover, it is possible to easily assemble the second brake discs.

It may be provided that the length of the screw engagement between the bolt and the inner element in the direction of the axis of rotation is at least 25% of the length of the circular cylindrical portion in the direction of the axis of rotation. The corresponding screw engagement can thus support a significant torque caused by forces acting transversely to the cylinder axis of the respective bolt.

It may be provided that the second brake discs comprise a plurality of circular apertures, each of which is penetrated by an associated bolt. This causes the fixed connection between the bolts and the second brake discs to be fixed. With the brake open, it is ensured that the second brake discs can move only slightly radially to the axis of rotation, thus preventing noise during operation.

It may be provided that the circular aperture is adapted with clearance to the circular cylindrical portion of the bolt. The specified clearance is preferably designed as small as possible so that the surface pressure in contact between the aperture and the bolt is minimized. However, a lower limit for the clearance from the requirement that the second brake discs must be able to move freely in the direction of the axis of rotation relative to the bolts when the brake is open.

A fluid distributor may be is provided, which is fixedly connected to the outer element with respect to the axis of rotation, wherein it is supported in the direction of the axis of rotation on the inner element, wherein at least some of the second brake discs are arranged around the fluid distributor, wherein they are each spaced apart directly opposite the fluid distributor. As a result, installation space can be saved.

Of course, the above-mentioned features and those to be explained below can be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The figure shows:

FIG. 1 a longitudinal section of a hydrostatic rotary machine according to the present disclosure;

FIG. 2 a perspective view of the hydrostatic rotary machine of FIG. 1, wherein the portion of the outer element supporting the fluid router is removed;.

FIG. 3 a perspective view of a bolt;

FIG. 4 a perspective view of the inner element with the bolts; and

FIG. 5 a partial section of the hydrostatic rotary machine of FIG. 1 in the area of a bolt.

### DETAILED DESCRIPTION

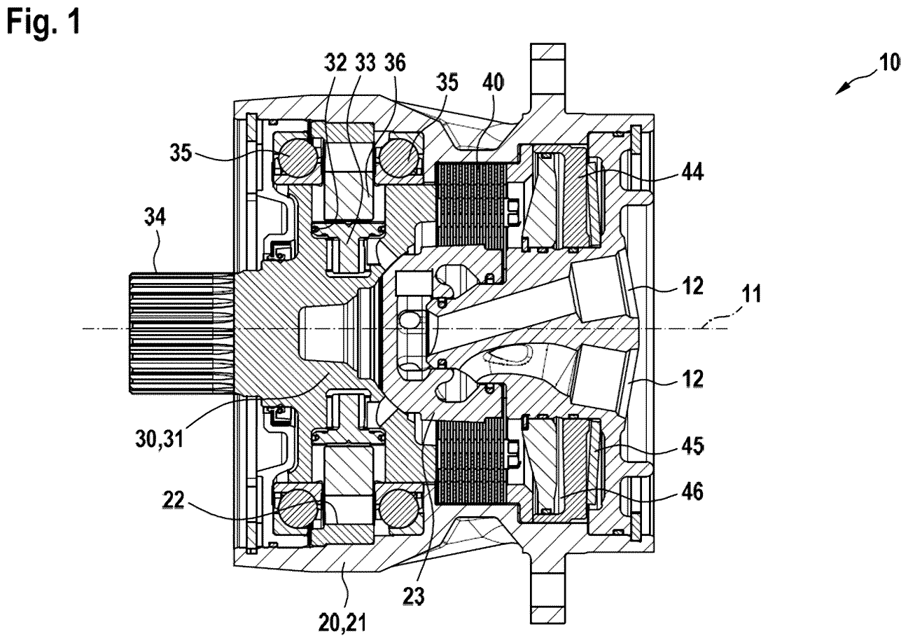

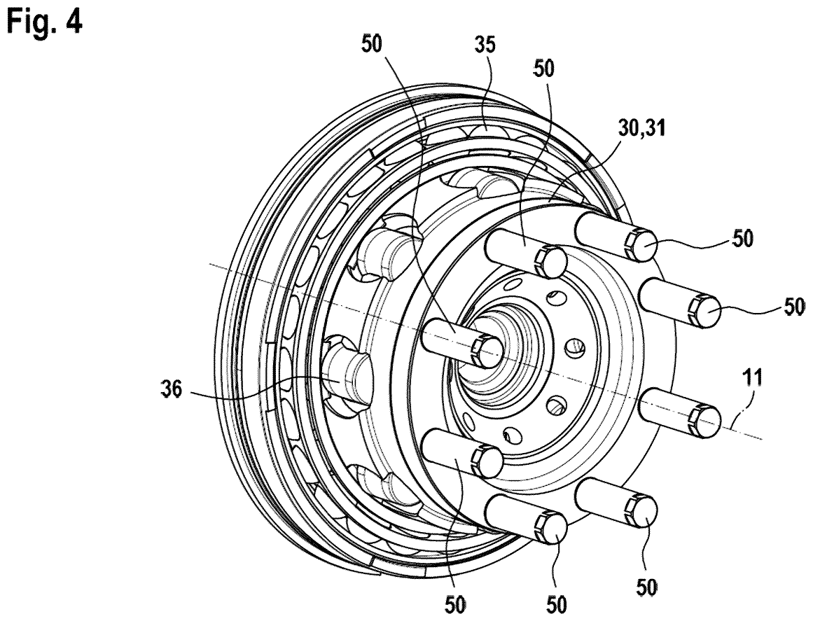

FIG. 1 shows a longitudinal section of a hydrostatic rotary machine 10 according to the present disclosure. The cutting plane contains the axis of rotation 11 and runs centrally through a piston 33. The hydrostatic rotary machine 10 includes an inner 30 and an outer element 20 that are rotatable relative to each other relative to an axis of rotation 11. In the present case, they are supported against one another by way of two pivot bearings 35. The outer element 20 forms the stator 21 of the hydrostatic rotary machine 10. On its inner circumferential surface, a cam track 22 is formed, which extends undulating around the axis of rotation 11. The pistons 33 abut the cam track 22 via rotatable rollers 36. It is noted here that the present FIGS. 1 and 4 show the pistons in the fully retracted state, so that contrary to the ratios in operation, the cam track 22 is not abutted. Pistons 33 are received in cylinders 32 of inner element 30 so that they can radially move relative to the axis of rotation 11. In the present case, the inner element 30 forms the rotor 31 of the hydrostatic rotary machine 10. It projects with a drive pin 34 out of the outer element 20.

A separate fluid distributor 23 is fixedly connected to the outer element 20 with respect to the axis of rotation 11 and supported on the inner element in the direction of the axis of rotation 11. The cylinders 32 are connected to the two work ports 12 via the fluid distributor 23 such that a rotational movement of the rotor 31 is associated with fluid exchange between the two work ports 12. The hydrostatic rotary machine 10 is preferably used with a fluid during operation. The fluid is preferably a liquid, most preferably hydraulic oil.

The hydrostatic rotary machine 10 is equipped with a brake 40, which is configured as a multi-disc brake. The brake 40 includes a brake piston 44 that is linearly movable in the direction of the axis of rotation 11. The brake piston 44 is biased with a spring 45 in the closed position of the brake 40, in which a rotational movement of rotor 31 is blocked. By pressurizing a brake chamber 46, the brake 40 may be released.

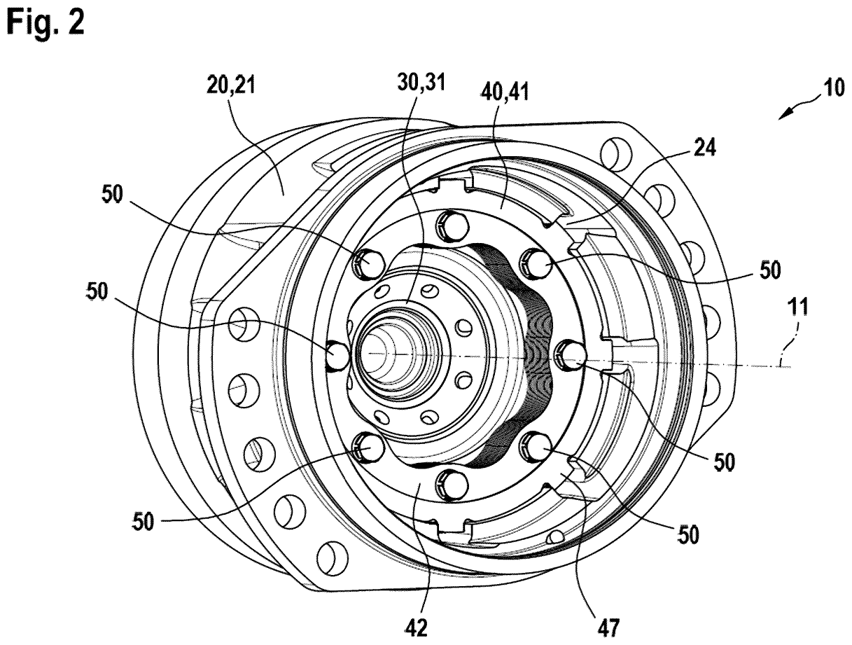

FIG. 2 shows a perspective view of the hydrostatic rotary machine 10 of FIG. 1, wherein the portion of the outer element 20 supporting the fluid router is removed. The brake 40 includes a plurality of first brake discs 41 that are rotationally fixedly connected to the outer element 20 relative to the axis of rotation 11, wherein they are movable in the direction of the axis of rotation 11. The first brake discs 41 are each provided with several extensions 47 facing radially outward with respect to the axis of rotation 11, each of which engages positively in an associated groove 24 on the outer element 20.

The second brake discs 42 are rotationally fixedly connected to the inner element 30 with respect to the axis of rotation 11, wherein they are movable in the direction of the axis of rotation 11. This connection is achieved by way of a plurality of, in the present case eight, bolts 50, which are preferably arranged uniformly around the axis of rotation 11. The extensions 47 described above are arranged so uniformly around the axis of rotation 11 that a bolt 50 and an associated extension 47 lie on a common imaginary radial beam relative to the axis of rotation 11.

The first and the second brake discs 41; 42 are arranged alternately in the direction of the axis of rotation 11, resulting in a multi-disc brake.

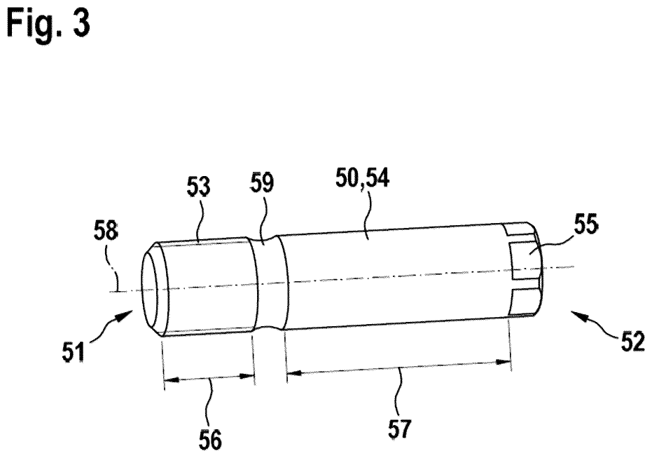

FIG. 3 shows a perspective view of a bolt 50. Each bolt 50 extends along a cylinder axis 58 that is oriented parallel to the axis of rotation. It has a first end 51, which is provided with an external thread 53, which in turn is screwed into an internal thread of the inner element. The external thread 53 is followed by a circular cylindrical section 54 that is circular cylindrical with respect to cylinder axis 58. The second end 52 of the bolt 50 opposite the first end 51 is provided with a positive locking mechanism 55, which in the present case is configured as an external hexagon. There, a screwing tool may be attached to thread the bolt 50 into the inner element at the required torque. The mentioned positive locking mechanism 55 is configured so as not to impede the sliding of the second brake discs. In particular, its largest diameter is at most as large as the diameter of the circular cylindrical portion 54.

The bolts 50, preferably with the brake 40 closed, are capable of supporting a significant force without the bolts 50 significantly bending.

The screw connection at the first end 51 is therefore preferably configured to support a torque. For this purpose, in particular, the length of the screw engagement 56 is at least 25% of the length of the circular cylindrical portion 57. The outer diameter of the outer thread 53 is preferably formed smaller than the outer diameter of the circular cylindrical portion 54, with a free-cut 59 arranged at the corresponding transition. The corresponding screw connection is preferably designed such that the axial screwing force in the area of the free-cut 59 is supported on the inner element.

FIG. 4 shows a perspective view of the inner element 30 with the bolts 50. The pistons with the rollers 36 are arranged uniformly distributed around the axis of rotation 11. The bolts 50 are also arranged uniformly distributed around the axis of rotation 11, wherein they are arranged circumferentially exactly between two directly adjacent pistons 33.

In FIG. 4, it can also be seen that the bolts 50 are screwed into the remaining inner element 30 up to the free-cut (No. 59 in FIG. 3), so that the circular cylindrical portion (No. 54 in FIG. 3) reaches directly to the remaining inner element 30.

It can further be seen in FIG. 4 that the pivot bearing 35 is configured as an angular contact ball bearing, which is equipped with a cage.

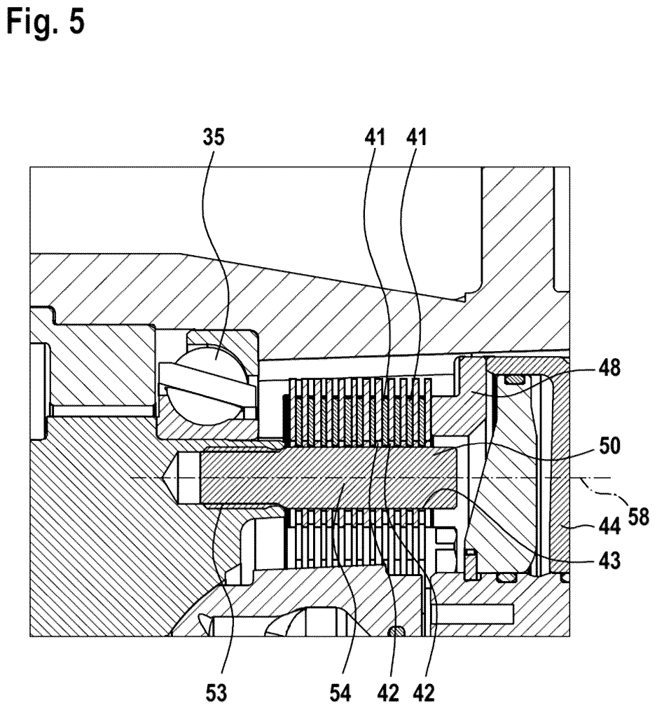

FIG. 5 shows a partial section of the hydrostatic rotary machine of FIG. 1 in the area of a bolt 50. The cutting plane includes the axis of rotation and runs centrally through the bolt 50 shown. The first 41 and second brake discs 42 can be seen, which are arranged alternately next to each other in the direction of the axis of rotation. The second brake discs 42 each have a circular aperture 43 for each bolt 50 that is adapted to the bolt 50 with some clearance. The circular cylindrical portion 54 of the bolt 50 intersects the mentioned apertures 43, such that the braking forces acting during operation are supported at the circular cylindrical portion 54.

Further, in FIG. 5, a pressure ring 48 can be seen with which the force of the brake piston is transferred to the first 41 and the second brake discs 42.

### REFERENCE NUMERALS

10 Hydrostatic rotary machine
11 Axis of rotation
12 Working port
20 Outer element
21 Stator
22 Cam track
23 Fluid distributor
24 Groove
30 Inner element
31 Rotor
32 Cylinder
33 Piston
34 Drive pin
35 Rotary bearing
36 Roller
40 Brake
41 First brake disc
42 Second brake disc
43 Circular breakthrough
44 Brake piston
45 Spring
46 Brake chamber
47 Extension
48 Pressure ring
50 Bolt
51 First end
52 Second end
53 External threading
54 Circular cylindrical portion
55 Positive locking mechanism
56 Length of the screw engagement
57 Length of the circular cylindrical portion
58 Cylinder axis
59 Undercut

What is claimed is:

1. A hydrostatic rotary machine having an inner and an outer element, which are coaxial with respect to an axis of rotation and rotatable relative to one another, wherein one of the inner and outer elements is a rotor and the other is a stator, wherein pistons, which are movable in cylinders are configured to cooperate with a cam track in such a way that a rotational movement of the rotor is associated with a stroke movement of the pistons, wherein a brake is provided which is designed to counteract the rotational movement of the rotor relative to the stator, wherein the brake comprises a plurality of first and a plurality of second brake discs arranged alternately along the axis of rotation, wherein the first brake discs are rotationally fixedly connected to the outer element with respect to the axis of rotation, wherein at least two bolts each extending parallel to the axis of rotation are provided, wherein the at least two bolts are fixedly connected to the inner element at a single first end facing toward the axis of rotation, and wherein each bolt intersects all second brake discs such that the second brake discs are rotationally fixedly connected to the inner element with respect to the axis of rotation.

2. The hydrostatic rotary machine according to claim 1, wherein the number of bolts is equal to the number of pistons.

3. The hydrostatic rotary machine according to claim 2, wherein the pistons and the bolts are each arranged uniformly distributed around the axis of rotation, and wherein the bolts are arranged circumferentially with respect to the axis of rotation between the pistons.

4. The hydrostatic rotary machine according to claim 1, wherein a radially outward facing extension is associated with each bolt on all first brake discs, and wherein the extensions engage in a respective associated groove on the outer element.

5. The hydrostatic rotary machine according to claim 1, wherein the bolts are each designed as separate components, each of which is screwed into the inner element at the first end.

6. The hydrostatic rotary machine according to claim 5, wherein the bolts are provided with a positive locking mechanism at a second end facing away from the first end in the direction of the axis of rotation, which are configured for positively engaging with a screwing tool.

7. The hydrostatic rotary machine according to claim 1, wherein the bolt has a circular cylindrical portion outside the inner element, the cylinder axis of which is arranged parallel to the axis of rotation, and wherein the second brake discs are arranged in the area of the circular cylindrical portion.

8. The hydrostatic rotary machine according to claim 7, wherein the bolts are each designed as separate components, each of which is screwed into the inner element at the first end, and wherein the length of the screw engagement between the bolt and the inner element in the direction of the axis of rotation is at least 25% of the length of the circular cylindrical portion in the direction of the axis of rotation.

9. The hydrostatic rotary machine according to claim 7, wherein the second brake discs comprise a plurality of circular apertures, each of which is penetrated by an associated bolt.

10. The hydrostatic rotary machine according to claim 9, wherein the circular aperture is configured with clearance to the circular cylindrical portion of the bolt.

11. The hydrostatic rotary machine according to claim 1, wherein a fluid distributor is provided, which is fixedly connected to the outer element with respect to the axis of rotation, wherein the fluid distributor is supported in the direction of the axis of rotation on the inner element, wherein at least some of the second brake discs are arranged around the fluid distributor, and wherein the at least some of the second brake discs are each spaced apart directly opposite the fluid distributor.
